(19) United States
(12) Patent Application Publication
(10) Pub. No.: US 2008/0018792 A1
(43) Pub. Date: Jan. 24, 2008

(54) Systems and Methods for Interactive Surround Visual Field

(76) Inventors: Kiran Bhat, San Francisco, CA (US); Kar-Han Tan, Palo Alto, CA (US); Anoop K. Bhattacharjya, Campbell, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/458,598

(22) Filed: Jul. 19, 2006

(51) Int. Cl. H04N 9/74

(52) U.S. Cl. 348/578

(57) ABSTRACT

A surround visual field framework or system and methods are presented. In an embodiment, a surround visual field system comprises a control signal extractor that obtains a control signal that is related to the input stream. The control signal is provided to a coupling rule that links the control signal to an effect on an element of a surround visual field. The effect is applied to the element of the surround visual field thereby creating a surround visual field that has a characteristic or characteristics which relate to an input audio/visual stream presentation. In one embodiment, the surround visual field is displayed in an area partially surrounding or surrounding the input stream being displayed. In embodiments, the surround visual field may be a rendering of a three-dimensional environment. In embodiments, one or more otherwise idle display areas may be used to display a surround visual field.

### CROSS-REFERENCE TO RELATED APPLICATIONS

This application is related to co-pending and commonly-assigned U.S. patent application Ser. No. 11/294,023, filed on Dec. 5, 2005, entitled “IMMERSIVE SURROUND VISUAL FIELDS,” listing inventors Kar-Han Tan and Anoop K. Bhattacharjya, which is incorporated by reference in its entirety herein.

This application is related to co-pending and commonly-assigned U.S. patent application Ser. No. 11/390,932, filed on Mar. 28, 2006, entitled “SYSTEMS AND METHODS FOR UTILIZING IDLE DISPLAY AREA,” listing inventors Kiran Bhat and Anoop K. Bhattacharjya, which is incorporated by reference in its entirety herein.

This application is related to co-pending and commonly-assigned U.S. patent application Ser. No. 11/390,907, filed on Mar. 28, 2006, entitled “SYNTHESIZING THREE-DIMENSIONAL SURROUND VISUAL FIELD,” listing inventors Kiran Bhat, Kar-Han Tan, and Anoop K. Bhattacharjya, which is incorporated by reference in its entirety herein.

### BACKGROUND

A. Technical Field

The present invention relates generally to the visual enhancement of an audio/video presentation, and more particularly, to the synthesis and display of a surround visual field relating to the audio/visual presentation.

B. Background of the Invention

Various technological advancements in the audio/visual entertainment industry have greatly enhanced the experience of an individual viewing or listening to media content. A number of these technological advancements improved the quality of video being displayed on devices such as televisions, movie theatre systems, computers, portable video devices, and other such electronic devices. Other advancements improved the quality of audio provided to an individual during the display of media content. These advancements in audio/visual presentation technology were intended to improve the enjoyment of an individual or individuals viewing this media content.

An important ingredient in the presentation of media content is facilitating the immersion of an individual into the presentation being viewed. A media presentation is oftentimes more engaging if an individual feels a part of a scene or feels as if the content is being viewed “live.” Such a dynamic presentation tends to more effectively maintain a viewer's suspension of disbelief and thus creates a more satisfying experience.

This principle of immersion has already been significantly addressed in regards to an audio component of a media experience. Audio systems, such as Surround Sound, provide audio content to an individual from various sources within a room in order to mimic a real-life experience. For example, multiple loudspeakers may be positioned in a room and connected to an audio controller. The audio controller may have a certain speaker produce sound relative to a corresponding video display and the speaker location within the room. This type of audio system is intended to simulate a sound field in which a video scene is being displayed.

Current video display technologies have not been as effective in creating an immersive experience for an individual. Several techniques use external light sources or projectors in conjunction with traditional displays to increasing the sense of immersion. For example, the Philips Ambilight TV projects colored backlights behind the television. Such techniques are deficient because they are extremely limited and cannot provide any complex immersive effects. Furthermore, current video display devices oftentimes fail to provide adequate coverage of the field of view of an individual watching the device or fail to utilize significant portions of a display. As a result, the immersive effect is lessened.

Accordingly, what is desired are systems, devices, and methods that address the above-described limitations.

### SUMMARY OF THE INVENTION

Disclosed are systems and methods for generating a surround visual field. In an embodiment, a method for generating a surround visual field may comprise creating a coupling rule that receives a control signal as an input and outputs an effect on at least one element of the surround visual field. In one embodiment, the user may define or alter the coupling rule. In an embodiment, the input stream is analyzed to obtain a control signal that is related to an input stream and that control signal is provided to the coupling rule so that an effect may be applied to at least one element of the surround visual field. The resulting surround visual field may be displayed in an area that surrounds or partially surrounds an area displaying the input stream, thereby enhancing the viewing experience of a user or users.

In an embodiment, the element of the surround visual field may be an articulate element, and the coupling rule may be a behavior model. In one embodiment, the behavior model may comprise a plurality of motion clips of the articulated element and a transition between two or more of the plurality of motion clips of the element may be related to the control signal. In one embodiment, the behavior model may be a Markov model.

In an embodiment, a computer-readable medium may carry one or more sequences of instructions which, when executed by one or more processors, cause the one or more processors to perform one or more of the above mentioned steps.

It should be noted that the control signal and coupling rule may be (1) a local control signal and coupling rule; (2) a global control signal and a growth coupling rule; or (3) both.

In an embodiment, the effect may be applied to multiple elements in the surround visual field.

In one embodiment, an element may have more than one effect applied to it wherein the resulting effect may be the superposition of all the effects applied to the element.

In an embodiment, a global control signal may be derived from one or more local control signals.

In an embodiment, a surround visual field system for generating a surround visual field that comprises a plurality of elements may comprise a control signal extractor that receives the input stream and obtains a control signal that is related to the input stream; and a coupling rule that receives the control signal as an input and outputs an effect on at least one element from the plurality of elements of the surround visual field.

In an embodiment, the coupling rule may be behavior model. In an embodiment, the coupling rule may be a growth model. In an alternative embodiment, the coupling rule may be a combination of a behavior model and a growth model.

In an embodiment, the control signal extractor may extract a local control signal and a global control signal. In one embodiment, the system may also have a coupling rule associated with the local control signal and a coupling rule associated with the global control signal. In an embodiment, the coupling rule associated with the global control signal may be a growth model.

Although the features and advantages of the invention are generally described in this summary section and the following detailed description section in the context of embodiments, it shall be understood that the scope of the invention should not be limited to these particular embodiments. Many additional features and advantages will be apparent to one of ordinary skill in the art in view of the drawings, specification, and claims hereof.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is an illustration of a surround visual field according to one embodiment of the invention.

FIG. 2 graphically depicts an embodiment of surround visual field framework or system according to one embodiment of the invention.

FIG. 3 is an illustration of method for computing pan-tilt-zoom components from a motion vector field according to an embodiment of the invention.

FIG. 4 is an illustration of an element model, in this case a puffer fish, including its wire mesh and skeletal frame according to one embodiment of the invention.

FIGS. 5A and 5B depict portions of sequences from two different motion clips (swimming and scared) for a puffer fish model according to one embodiment of the invention.

FIG. 6 is a diagram of an element behavior model comprising a set of motion clips according to one embodiment of the invention.

FIG. 7 is an exemplary Markov diagram mapping transitions between two states according to one embodiment of the invention.

FIG. 8 depicts two exemplary Markov diagram with different probabilities related to the transitions between two states according to one embodiment of the invention.

FIG. 9 depicts different screenshots of an exemplary surround visual field generated by a surround visual framework according to one embodiment of the invention.

FIG. 10 graphically depicts an embodiment of surround visual field framework or system according to one embodiment of the invention.

FIGS. 11A-D graphically depicts an embodiment of surround visual field that is affected a growth model according to one embodiment of the invention.

FIG. 12 illustrates an embodiment of method for generating a surround visual field according to one embodiment of the invention.

### DETAILED DESCRIPTION OF THE PREFERRED EMBODIMENTS

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different systems and devices including projection systems, theatre systems, televisions, home entertainment systems, and other types of audio/visual entertainment systems. The embodiments of the present invention may also be present in software, hardware, firmware, or combinations thereof. Structures and devices shown below in block diagram are illustrative of exemplary embodiments of the invention and are meant to avoid obscuring the invention. Furthermore, connections between components and/or modules within the figures are not intended to be limited to direct connections. Rather, data between these components and modules may be modified, re-formatted, or otherwise changed by intermediary components and modules.

Reference in the specification to “one embodiment” or “an embodiment” means that a particular feature, structure, characteristic, or function described in connection with the embodiment is included in at least one embodiment of the invention. The appearances of the phrase “in one embodiment” or “in an embodiment” in various places in the specification are not necessarily all referring to the same embodiment.

Systems and methods are disclosed for animating one or more objects in a surround visual field. In an embodiment, a surround visual field is a synthesized, or generated, display that may be shown in conjunction with a main audio/visual presentation in order to enhance the presentation. A surround visual field may comprise one or more elements including, but not limited to, images, patterns, colors, shapes, textures, graphics, texts, objects, characters, and the like.

In an embodiment, one or more elements within the surround visual field may relate to, or be responsive to, the main audio/visual presentation. In one embodiment, one or more elements within the surround visual field, or the surround visual field itself, may visually change in relation to the audio/visual content or the environment in which the audio/visual content is being displayed. For example, elements within a surround visual field may move or change in relation to motion, sounds, and/or color within the audio/video content being displayed.

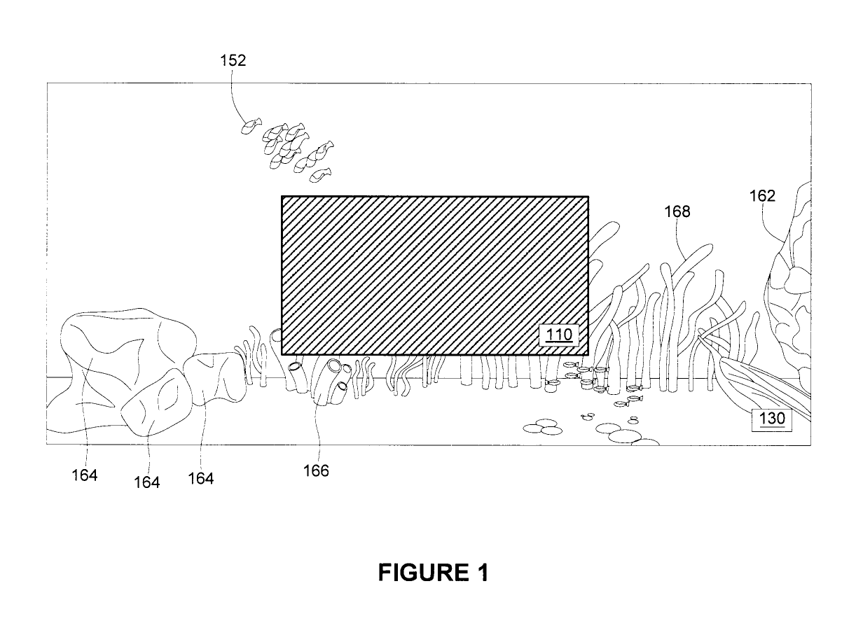

FIG. 1 depicts an exemplary embodiment of a surround visual field 130. In the embodiment in FIG. 1, the main audio/visual presentation, or input stream, 110 is centrally displayed. In the depicted embodiment, the surround visual field 130 surrounds the input stream 110, although it should be noted that the surround visual field 130 need not surround the input stream. Rather, the surround visual field may only partially surround the input stream, including without limitation, being displayed adjacent to the input stream. It should also be noted that the input stream field 110, the surround visual field 130, or both need not be a rectangular shape; either field may be a regular or irregular shape.

Returning to FIG. 1, the surround visual field 130 comprises a number of background and foreground elements. Background elements include various rocks 162 and 164, coral 166, and plants 168. Foreground elements include a pool of fish 152. One or more of these elements may be made to respond to the input stream 110. Background elements, such as the rocks 162 and 164, the corral 166, and the plants 168, may have their color affected by the color or lighting in the input stream 1 10. Plant 168 may have its motion related to motion in the input stream 110. Furthermore, in an embodiment, foreground elements, such as the pool of fish 152, may also have their color, behavior, and/or motion affected by the input stream 110.

The present invention discloses exemplary frameworks, or systems, for animating elements within a surround visual field. Also disclosed are some illustrative methods for utilizing the system to generate a surround visual field.

A. Surround Visual Field System or Framework

Embodiments of the present invention present a scalable, real-time framework, or system, for creating a surround visual field that is responsive to an input stream. In an embodiment, the framework may be used to affect foreground objects in a surround video field. In an embodiment, the framework may also be used to affect background elements, including but not limited to terrain, lighting, sky, water, background object, and the like, using one or more control signals, or cues, extracted from the input stream.

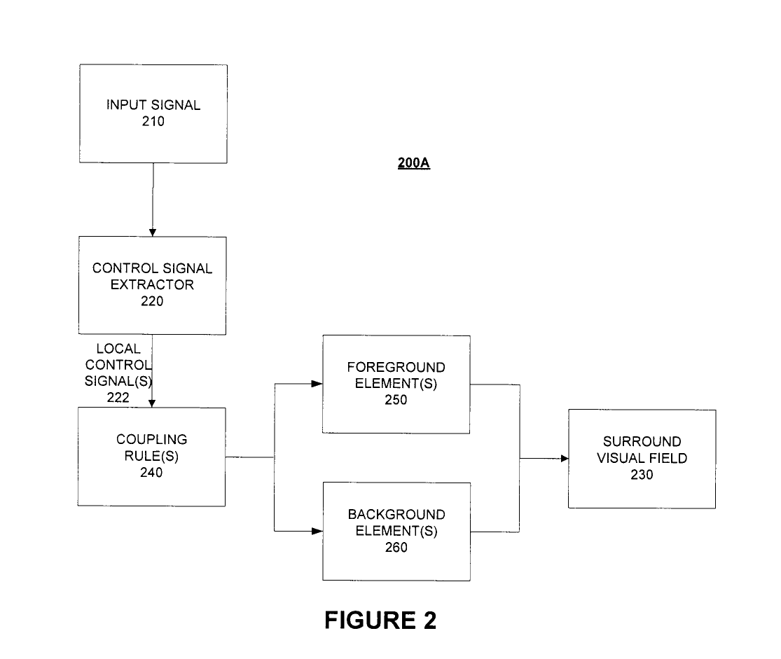

FIG. 2 depicts an embodiment of a surround visual field system or framework 200A. Framework 200 may be implemented using a general purpose computer and/or a special purpose computer, particularly one designed for graphics processing or containing a graphic processing unit, such as, for example, NVIDIA® 6800 GeForce or ATI Radeon® graphics processing units. Framework 200A, or portions thereof, may be implemented in hardware, software, firmware, or a combination thereof. An input stream 210 is provided to a control signal extractor 220. The control signal extractor 220 may obtain one or more control signals, or cues, from the input stream 210. Control signals may represent a value, a function, a set of values, a set of functions, or a combination thereof. Control signals may be obtained from the audio or video, or may be provided via an input means from a user or viewer. In an embodiment, a content provider may embed control signals in the input stream or include control signals on a data channel.

Examples of the control signals obtained from the audio include, but are not limited to, phase differences between audio channels, volume levels, audio frequency characteristics, and the like. Examples of control signals from the video include, but are not limited to, motion, color, lighting (such as, for example, identifying the light source in the video or an out of frame light source), and the like. Content recognition techniques may also be used to obtain information about the input stream content.

In an embodiment, the control signal extractor 220 may create a model of motion between successive video frame pairs. In an alternative embodiment, control signal extractor 220 or the coupling rules module 240 may extrapolates the motion model beyond the boundaries of the input stream video frame and use that extrapolation to control the surround visual field, in relation to the extrapolated motion model. In one embodiment, the optic flow vectors may be identified between successive video frame pairs and used to build a global motion model. In an embodiment, an affine model may be used to model motion in the input stream.

In an embodiment, the control signal extractor 220 analyzes motion between an input stream video frame pair and creates a model from which motion between the frame pair may be estimated. The accuracy of the model may depend on a number of factors including, but not limited to, the accuracy of the estimated optical flow, the density of the optic flow vector field used to generate the model, the type of model used and the number of parameters within the model, and the amount and consistency of movement between the video frame pair. The embodiment below is described in relation to successive video frames; however, the present invention may estimate and extrapolate motion between any two or more frames within a video signal and use this extrapolated motion to control a surround visual field.

In one example, motion vectors that are encoded within a video signal may be extracted and used to identify motion trajectories between video frames. One skilled in the art will recognize that these motion vectors may be encoded and extracted from a video signal using various types of methods including those defined by various video encoding standards (e.g. MPEG, H.264, etc.). In another example, optic flow vectors may be identified that describe motion between video frames. Various other types of methods may also be used to identify motion within a video signal; all of which are intended to fall within the scope of the present invention.

In one embodiment of the invention, the control signal extractor may identify a plurality of optic flow vectors between a pair of frames. The vectors may be defined at various motion granularities including pixel-to-pixel vectors and block-to-block vectors. These vectors may be used to create an optic flow vector field describing the motion between the frames.

The vectors may be identified using various techniques including correlation methods, extraction of encoded motion vectors, gradient-based detection methods of spatio-temporal movement, feature-based methods of motion detection and other methods that track motion between video frames.

Correlation methods of determining optical flow may include comparing portions of a first image with portions of a second image having similarity in brightness patterns. Correlation is typically used to assist in the matching of image features or to find image motion once features have been determined by alternative methods.

Motion vectors that were generated during the encoding of video frames may be used to determine optic flow. Typically, motion estimation procedures are performed during the encoding process to identify similar blocks of pixels and describe the movement of these blocks of pixels across multiple video frames. These blocks may be various sizes including a 16×16 macroblock, and sub-blocks therein. This motion information may be extracted and used to generate an optic flow vector field.

Gradient-based methods of determining optical flow may use spatio-temporal partial derivatives to estimate the image flow at each point in the image. For example, spatio-temporal derivatives of an image brightness function may be used to identify the changes in brightness or pixel intensity, which may partially determine the optic flow of the image. Using gradient-based approaches to identifying optic flow may result in the observed optic flow deviating from the actual image flow in areas other than where image gradients are strong (e.g., edges). However, this deviation may still be tolerable in developing a global motion model for video frame pairs.

Feature-based methods of determining optical flow focus on computing and analyzing the optic flow at a small number of well-defined image features, such as edges, within a frame. For example, a set of well-defined features may be mapped and motion identified between two successive video frames. Other methods are known which may map features through a series of frames and define a motion path of a feature through a larger number of successive video frames.

In an embodiment, the control signals obtained from the input stream may represent a characteristic value (e.g., color, motion, audio level, etc.) at a specific instant in time in the input stream or over a relatively short period of time. These local signals allow elements in the surround visual field to correlate with events in video. For example, an instanteous event, such as an explosion, in the input stream can correlate via a local signal to a contemporaneous or relatively contemporaneous change in the surround visual field. In an embodiment, the nature, extent, and duration of the change these local signals will have on the surround visual field may be determined by one or more coupling rules.

B. Coupling Rules

The couple rules represent the linking between the local control signals and how a foreground or background element in the surround visual field will be affected. As shown in FIG. 2, an embodiment of the system or framework may contain one or more foreground 250 and/or background 260 elements. Foreground elements 250 may comprise any object, such as rocks, animals, insects, people, machines, plants, and the like. Background elements 260 may include any objects or textures and may be implemented by using any of a number of methods, including but not limited to sprite-based models, environment maps, procedural terrains, and the like. The information regarding these elements may be procedural rendered, that is, generated by a program, or may be stored in files. In an embodiment, the elements may be stored in “.x” file format and texture information may be stored in “.bmp” or “jpeg” file format-although it shall be noted that no particular file format is critical to the present invention. The coupling rules link these elements, foreground and/or background, to the controls signals in order to have the surround visual field be responsive to the input stream.

For example, in an embodiment, an aspect of the present invention may involve the synthesizing of three-dimensional environments for a surround visual field. In one embodiment, physics-based simulation techniques know to those skilled in the art of computer animation may be used not only to synthesize the surround visual field, but also as coupling rules. In an embodiment, to generate interactive content to display in the surround visual field, the parameters of two-dimensional and/or three-dimensional simulations may be coupled to or provided with control signals obtained from the input stream.

For purposes of illustration, consider the following embodiments of 3D simulations in which dynamics are approximated by a Perlin noise function. Perlin noise functions have been widely used in computer graphics for modeling terrain, textures, and water, as discussed by Ken Perlin in “An image synthesizer,” Computer Graphics (Proceedings of SIGGRAPH 1985), Vol. 19, pages 287-296, July 1985; by Claes Johanson in “Real-time water rendering,” Master of Science Thesis, Lund University, March 2004; and by Ken Perlin and Eric M. Hoffert in “Hypertexture,” Computer Graphics (Proceedings of SIGGRAPH 1989), Vol. 23, pages 253-262, July 1989, each of which is incorporated herein by reference in its entirety. It shall be noted that the techniques presented herein may be extended to other classes of 3D simulations, including without limitation, physics-based systems.

A one-dimensional Perlin function is obtained by summing up several noise generators Noise(x) at different amplitudes and frequencies:

$$N ( x ) = β {\sum }_{i = 1}^{octaves} {α}^{i} Noise ( {2}^{i} x ) \qquad ( 1 )$$

The function Noise(x) is a seeded random number generator, which takes an integer as the input parameter and returns a random number based on the input. The number of noise generators may be controlled by the parameter octaves, and frequency at each level is incremented by a factor of two. The parameter α controls the amplitude at each level, and β controls the overall scaling. A two-dimensional version of Equation (1) may be used for simulating a natural looking terrain. A three-dimensional version of Equation (1) may be used to create water simulations.

The parameters of a real-time water simulation may be driven using an input video stream to synthesize a responsive three-dimensional surround field. The camera motion, the light sources, and the dynamics of the three-dimensional water simulation may be coupled through coupling rules to motion vectors, colors, and audio signals sampled from the video.

In an embodiment, the motion of a virtual camera may be governed by dominant motions from the input video stream. To create a responsive “fly-through” of the three-dimensional simulation, an affine motion model may be fit to motion vectors from the input stream. An affine motion field may be decomposed into the pan, tilt, and zoom components about the image center (cₓ, c_{y}). These three components may be used to control the direction of a camera motion in simulation.

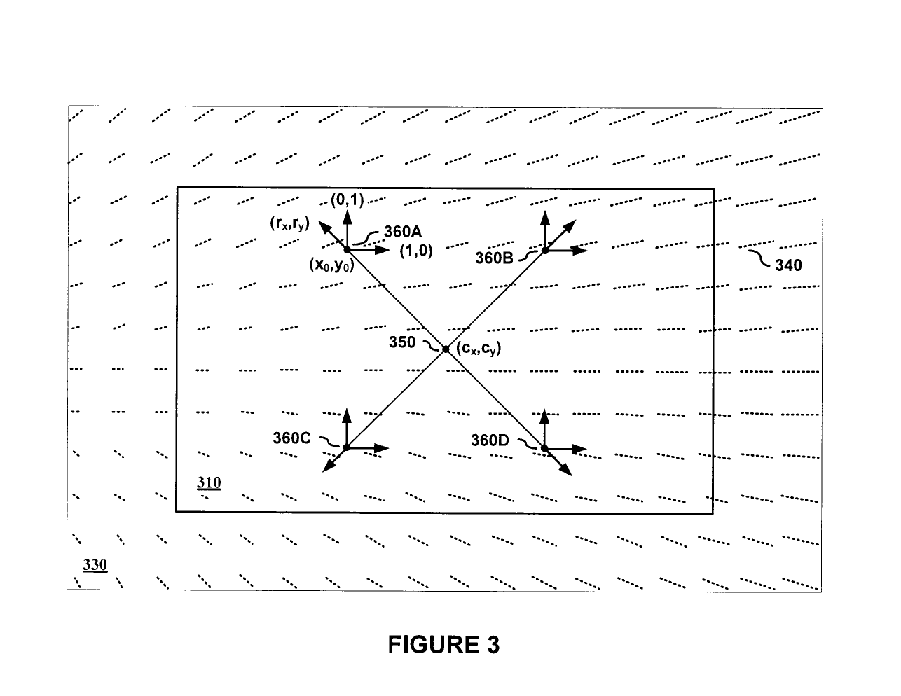

FIG. 3 depicts an input video stream 310 and motion vectors field 340, wherein the pan-tilt-zoom components may be computed from the motion vector field. In an embodiment, the pan-tilt-zoom components may be obtained by computing the projections of the motion vectors at four points 360A-360D equidistant from a center 350. The four points 360A-360D and the directions of the projections are depicted in FIG. 3.

The pan component may be obtained by summing the horizontal components of the velocity vector (uᵢ, vᵢ) at four symmetric points (xᵢ, yᵢ) 360A-360D around the image center 350:

$${V}_{pan} = {\sum }_{i = 1}^{4} ( {u}_{i} , {v}_{i} ) \cdot ( 1 , 0 ) \qquad ( 2 )$$

The tilt component may be obtained by summing the vertical components of the velocity vector at the same four points:

$${V}_{tilt} = {\sum }_{i = 1}^{4} ( {u}_{i} , {v}_{i} ) \cdot ( 0 , 1 ) \qquad ( 3 )$$

The zoom component may be obtained by summing the projections of the velocity vectors along the radial direction (rᵢ^{x}, rᵢ^{y}):

$${V}_{zoom} = {\sum }_{i = 1}^{4} ( {u}_{i} , {v}_{i} ) \cdot ( {r}_{i}^{x} , {r}_{i}^{y} ) \qquad ( 4 )$$

In embodiment, control signals may be used to control light sources in the three-dimensional synthesis. A three-dimensional simulation typically has several rendering parameters that control the final colors of the rendered output. The coloring in a synthesized environment may be controlled or affected by one or more color values extracted from the input stream. In an embodiment, a three-dimensional environment may be controlled or affected by a three-dimensional light source C_{light}, the overall brightness C_{avg}, and the ambient color C_{amb}. In one embodiment, for each frame in the video, the average intensity, the brightest color, and the median color may be computed and these values assigned to C_{avg}, C_{light}, and C_{amb} respectively. One skilled in the art will recognize that other color values or frequency of color sampling may be employed.

In an embodiment, the dynamics of a simulation may be controlled by the parameters α and β in Equation (1). By way of illustration, in a water simulation, the parameter α controls the amount of ripples in the water, whereas the parameter β controls the overall wave size. In an embodiment, these two simulation parameters may be coupled to the audio amplitude Aₐₘₚ and motion amplitude Mₐₘₚ as follows:

$$\begin{matrix}\dot{α} = f ( {A}_{amp} ) & ( 5 ) \\ \dot{β} = ( 1 - \frac{α}{2} ) g ( {M}_{amp} ) & ( 6 )\end{matrix}$$

where Mₐₘₚ=Vₚₐₙ+Vₜᵢₗₜ+V_{zoom}; f(.) and g(.) are linear functions that vary the parameters between their acceptable intervals (αₘᵢₙ, αₘₐₓ) and (βₘᵢₙ, βₘₐₓ). The above coupling rules or equations result in the simulation responding to both the audio and motion events in the input video stream.

It should be noted that the above discussion was presented to illustrate how control signals obtained from the input stream may be used to couple with the generating of the surround visual field in the framework 200, such as for example, using one or more parameters of a model to have one or more elements within the surround visual field respond to the input stream. Those skilled in the art will recognize other implementations may be embodiment to generate surround visual fields and such implementations fall within the scope of the present invention.

C. Articulated Elements

Another aspect of the present invention is its ability to animate one or more articulated elements, for example fish, birds, people, machines, etc., that may be made to move and/or to behave in response to the input stream. As explained in more detail below, the framework 200 enables elements in the surround visual field to exhibit a wide range of rich and expressive behaviors. Additionally, the framework allows for easy control of the global characteristics, such as motion and behavior, using few control parameters.

1. Model

An element, such as animals, insects, people, machines, and even plants, has a frame or skeleton. Modeling the frame or skeleton is beneficial in modeling how inputs, such as input forces, affect the element. Consider, by way of example, animals and people. These moving elements have articulated musculoskeletal frameworks for locomotion. The element's musculoskeletal frame determines the type and range of motions for the object.

The same principles of skeleton-based locomotion may be applied to virtual elements. In an embodiment, each character element may be represented using a triangular mesh with an underlying skeletal bone structure.

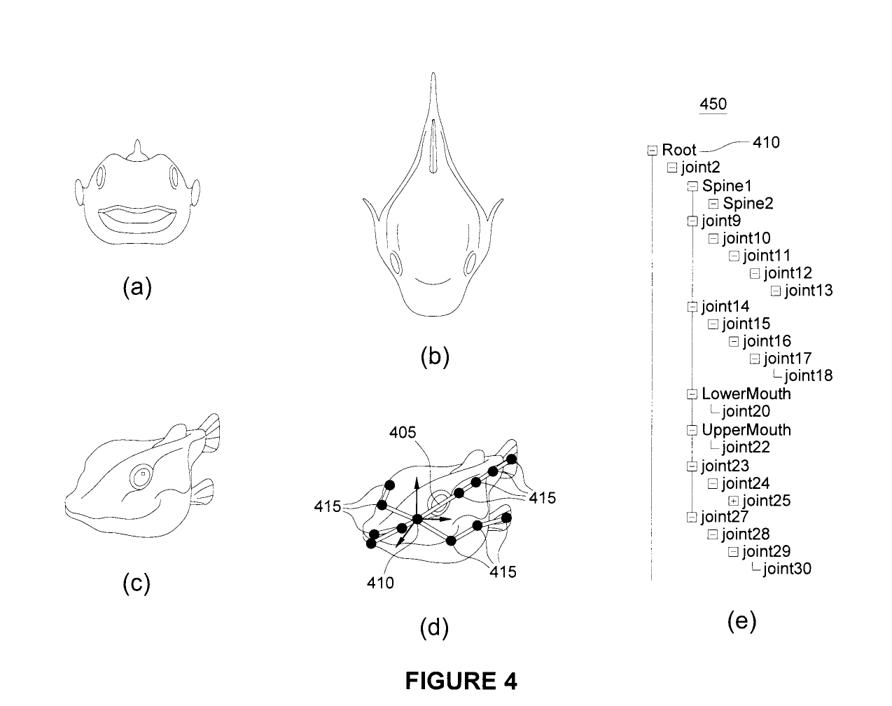

By way of example, FIGS. 4A-4D depict the front, top, and side views of a skinned articulated element, in this case a puffer fish, with an underlying hierarchy or skeleton. FIG. 4D depicts the puffer fish model with its wireframe model (not shown), skeletal hierarchy 405, and some exemplary joints 415.

In FIG. 4D, joints of the skeletal frame are illustrated with black circles 415 and are connected with bones 405. The skeletal frame possesses a root joint 410. FIG. 4E represents an exemplary hierarchy for the puffer model. The hierarchy is shown as a tree 450 whose nodes refer to the different joints in the skeletal model. In the depicted example, all the joints are children of, or dependent from, the root node or joint 410. It should be noted, therefore, that the motion of the root joint affects all children joints.

2. Animating Articulated Character Elements

In an embodiment, a character element may be animated by varying the root position and joint angles over time. The motion of the root joint controls the overall pose, including position and orientation, of the element, and the motion of the other joints create different behaviors. In an embodiment, these joint angles may be animated by an artist by posing the skeleton. In one embodiment, the framework 200 computes deformations of the mesh in response to the changes in the skeleton poses. This process of deforming the mesh in response to the changes in joint angles is called skinning. Examples of skinning are discussed by J. P. Lewis, Matt Cordner, and Nickson Fong in “Pose space deformations: A unified approach to shape interpolation and skeleton-driven deformation.” Proceedings of ACM SIGGRAPH 2000, Computer Graphics Proceedings, Annual Conference Series, pages 165-172, July 2000, which is incorporated by reference herein in its entirety.

In one embodiment, skinning may involve associating one or more regions of the mesh of the character with its underlying frame segment/bone, and updating these mesh regions (vertex positions) as the frame segments/bones move.

In an embodiment, to achieve real-time performance, portions of the animation framework may be implemented on a graphics processing unit (GPU) or graphic card. For example, embodiments of the present invention were performed using an NVIDIA® GeForce 6800 processor with a 256 megabit (MB) texture memory. One skilled in the art will recognize that no particular graphics processing unit is critical to the practice of the present invention.

In an embodiment, the skinning process may be implemented on a graphics card. That is, in an embodiment, the framework may implement skinning on hardware using vertex or pixel shaders. Each vertex on the base mesh may be influenced by a maximum number of bones. To compute the final, deformed position of a given vertex, the shader program may compute the deformation caused by all the joints affecting that particular vertex. The final position of the vertex may be a weighed average of these deformations. Because the deformations of each vertex is independent of other vertices in the mesh, the skinning step may be implemented on the GPU.

One skilled in the art will recognize that these and other modeling and animation techniques may be used for any of a number of objects, including without limitation, plants, animals, people, insects, machines, and the like.

3. Behavioral Model

In an embodiment, the motion of an element's frame may be designed by an artist using existing animation packages, such as Maya or Blender3D. The motion may be designed such that a sequence of joint angles, called motion clips, for the element corresponds to a unique behavior. These motion clips may be stored for retrieval by the framework 200. In an embodiment, the motion clips may be stored as “.x,” “.bmp,” and/or “jpeg” file formats and accessed by the framework 200. As noted previously, it shall be noted that no particular file format is critical to the present invention, and that the motion clips and other elements of the surround visual field may be stored in any file format now existing or later developed.

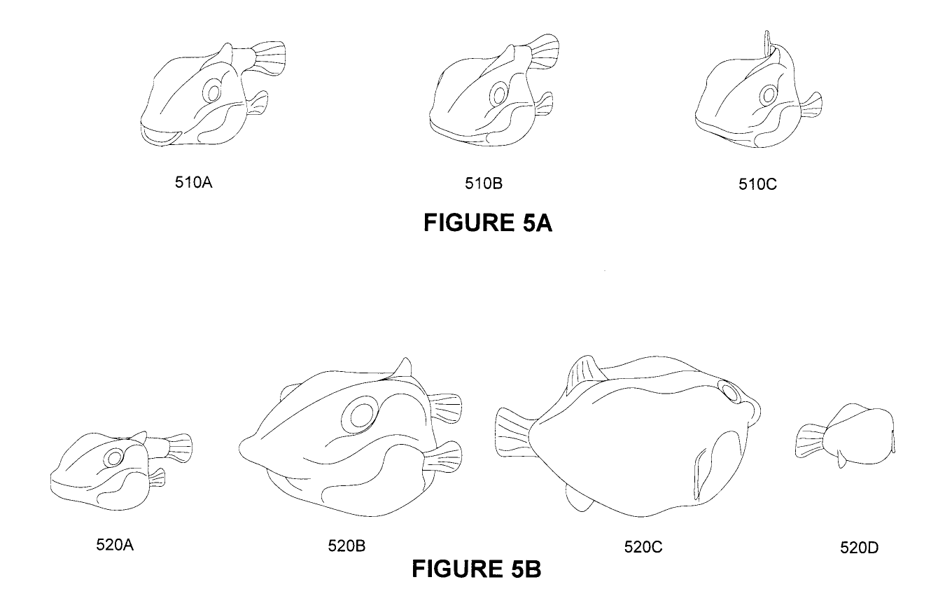

FIG. 5 depicts examples of two behaviors or motion clips for a puffer fish. FIG. 5A shows three frames 510A-510C sampled from a sequence of the puffer fish swimming. As the fish swims, its tailfin moves side-to-side. FIG. 5B shows four frames 520A-520D when the fish is scared. When scared, the fish puffs 520B and turns away 520C-520D during the sequence.

It shall be noted that the motion clips need not be linked to emotional traits, but may be applied any animation or motions, such as a machine performing specific tasks or a plant swaying, blooming, shedding its leaves, etc.

In an embodiment, the overall behavior of the element may be modeled using a collection of motion clips describing different behaviors. The collection may include one or more specific motion sequences.

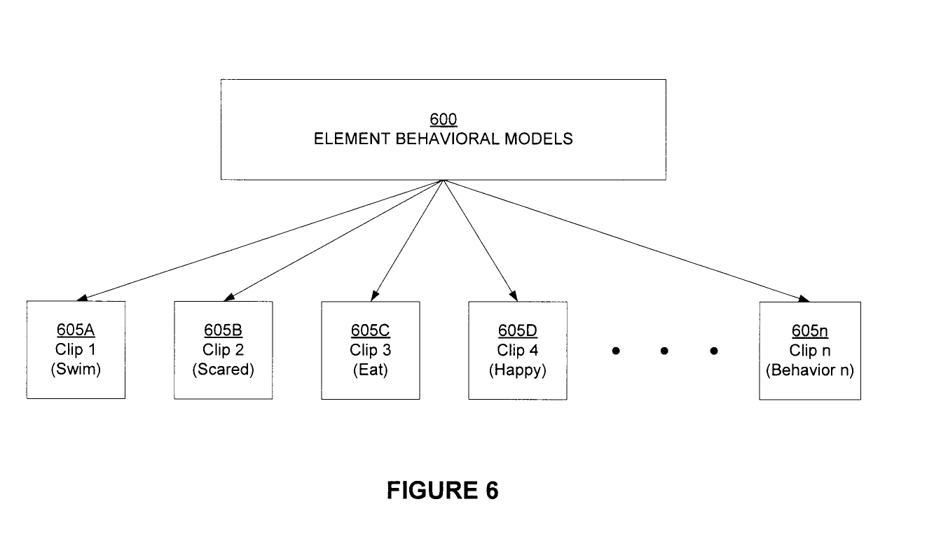

FIG. 6 depicts an example of a behavior model 600 for an element. The depicted behavior model 600 for the character element is a collection of several different motion clips 605A-605n, such as swim 605A, scared 605B, eat 605C, happy 605D, etc. Each motion clip 605 captures a unique behavior of the element, and is represented internally as a sequence of joint angles from the hierarchy. In an embodiment, these clips 605 may be created by an artist using general purpose animation software. As explained in more detail below, the framework 200 may be used to combine these clips in interesting ways to create a rich combination of behaviors for the element. That is, it shall be noted that combining the motion clips can result in a wide range of interesting and expressive character behavior.

4. Markov Model For Transitions

In one embodiment, the motion clips may be combined to create a combination of behaviors by using Markov models for transitions between motion clips. Markov models provide a simple mechanism for the element to change its behavior based on the events in an input stream.

Markov models may be used for capturing the overall element behavior using the collection of motion clips. In an embodiment, a Markov model represents each motion clip as a node in a graph. Transitions between these nodes may be controlled by one or more control signals, or cues, derived from the input audio-visual stream.

In an embodiment, it is assumed that the next state of the element depends only on the current state of the element and not on its history. In one embodiment, each element may have multiple states (e.g., happy, sad, scared, jump, run, hop, eat, etc.) and may have an uncertainty associated with the actions (e.g., by assigning a probability to each action), which allows for a rich set of object variations. In such cases, the element behavior may be explained mathematically using a Markov Decision Process (MDP).

It should be noted that an embodiment of the behavioral model may be based on transitions within a clip and between other clips. To synthesize smooth animations, transitions may be made continuous. In an embodiment, continuity may be achieved by smoothly morphing the vertex positions from the last pose of the previous clip to the first pose of the new clip. In an embodiment, this step may be implemented on a graphics processing unit as a vertex shader program.

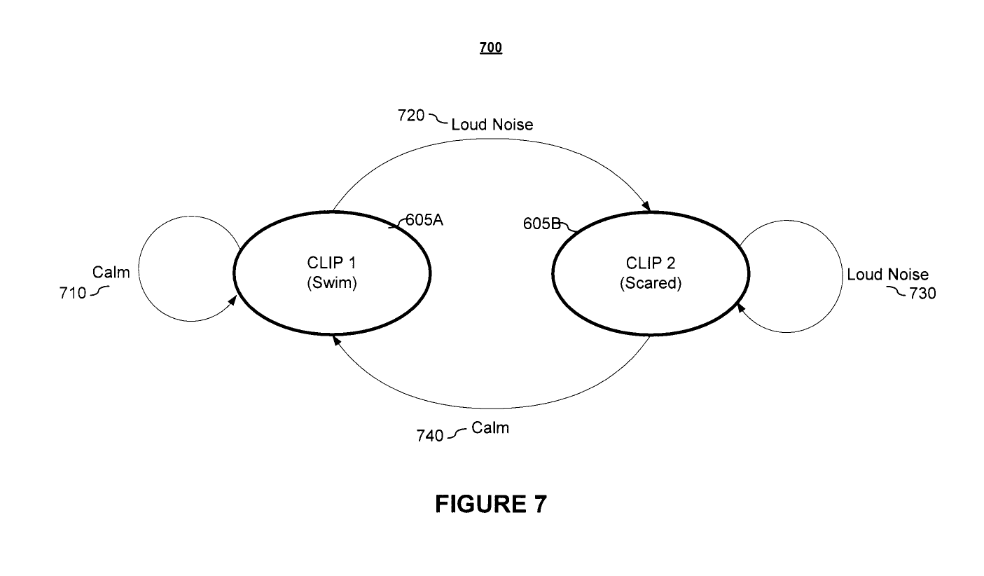

FIG. 7 depicts an exemplary state-action Markov model system 700 for modeling an element's dynamics. The transitions between the two states may be controlled by one or more control signals obtained from the input stream. For example, in the two-state Markov field depicted in FIG. 7, the state transitions may be controlled by an audio intensity control signal from the input stream. A coupling rule, such as the exemplary one listed below, may define that if the audio signal extracted from the input stream exceeds a threshold value, then the fish should transition 720 from the swim motion sequence (Clip 1) 605A to a scared motion sequence (Clip 2) 605B:

$$Object Behavior = \{ \begin{matrix}Swim ( Clip 1 ) , & audio < threshold \\ Scared ( Clip 2 ) , & audio \geq threshold\end{matrix} \qquad ( 7 )$$

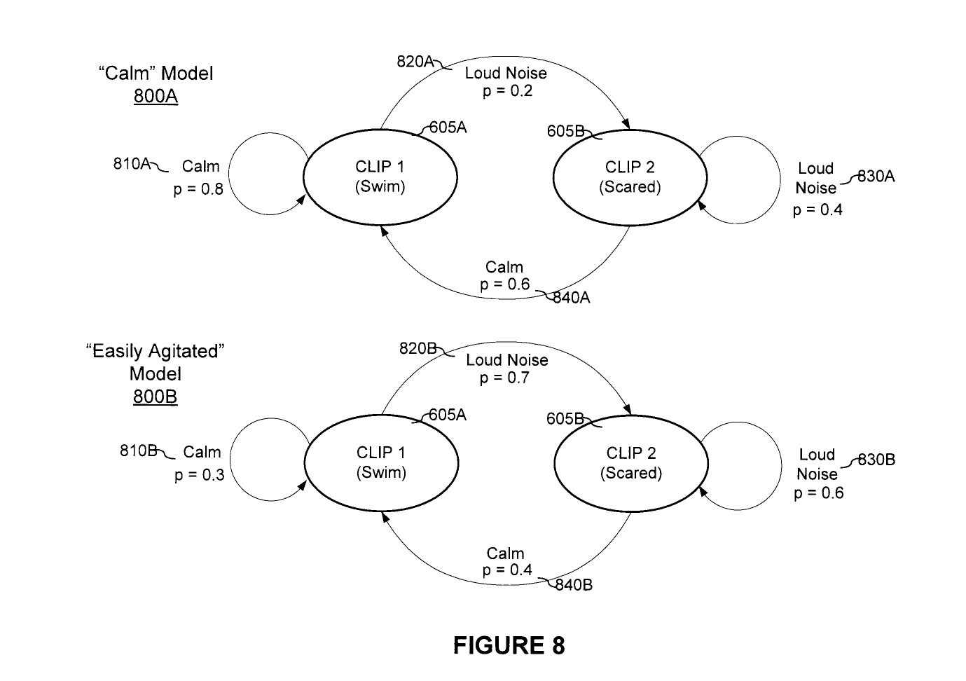

As mentioned previously, the coupling rules may also include uncertainty or variability associated with the behavior by assigning a probability to each action. For example, one or more puffer fish in a pool of fish may be assigned as “calm” fish, meaning that they have a predisposition to stay in a calm state of swimming. And, one or more puffer fish may be assigned as “easily agitated” fish, wherein they are more likely to get scared. For purposes of illustration, FIG. 8 depicts two two-state Markov models wherein one model 800A has probabilities assigned for the “calm” fish and one model 800B has probabilities assigned for the “easily agitated” fish. In the calm model 800A, the probabilities are set such that the fish has more of a tendency to want to remain calmly swimming. Whereas in the “easily agitated” model 800B, the fish is more sensitive to the input control signals and is more likely to be scared. One skilled in the art will recognize that by using probabilities, variation may be added into the framework 200—even between like elements. It shall be noted the probabilities utilized herein are for illustrative purposes only; no probability values or configurations are critical to the present invention.

One skilled in the art will recognize that a benefit of the framework 200 is its ability to allow a user to alter what control signals are extracted, the coupling rules, the probabilities, or more than one of these items thereby giving greater control over the responsiveness of the synthesized surround visual field.

5. Global Motion Model

As noted previously, an embodiment of the behavioral model uses the motion clips, which describe the variation of joint angles of the frame or skeleton. For example, the two motion clips in FIGS. 5A and 5B have different sets of joint angles over the length of the animation. However, it should be noted that the motion of the root joint controls the global motion of the element. For example, to make the fish swim to the left while being scared, the position of the root joint may be animated to move to the left while animating the rest of the hierarchy using joint angles from the scared motion clip. The motion of the root joint forces the entire skeleton to move along with it to the left. In an embodiment, a key-framing scheme may be implemented for the root joint pose for position, orientation, or both, which allows the ability to control the global motion of the element by specifying an appropriate set of key points.

D. Control

As noted previously, a beneficial aspect of the framework is its ability to easily control and program the global motion and behavior of the objects in the surround visual field. The character element model presented above has been designed to be easily controllable using a few set of parameters. Presented below are some of the different control parameters that may be used in the framework.

1. Global Motion Control

As mentioned previously, the root joint may be animated independently to generate a desired global trajectory. In an embodiment, the framework may use a key-framing approach to set the root joint trajectory. In one embodiment, the user may specify one or more control points. Given the key frame points, the framework 200 may interpolate these points to generate a smooth trajectory for the root joint. Quantities specified in the control points may include root positions XεR³, orientations θεR⁴, scale sεR³, and time—each of which may, in an embodiment, be interpolated along a trajectory. In an alternative embodiment, the framework may allow the root joint trajectory to be disturbed in response to one or more local control signals obtained from the input stream. In an embodiment, this result may be achieved by adding a noise displacement to the control points of the interpolated trajectory.

2. Behavior Control

In an embodiment, behavior control may be achieved by building a state-action graph or graphs for the given element. The framework allows for a wide range of control-from fully scripted character element responses to highly stochastic character element behavior. Typically, once a set of motion clips has been designed, a list of possible transitions between the different states may be defined. In an embodiment, the possible transitions between the different states may be weighted by probabilities. In an embodiment, a list of actions, or control signals and coupling rules, corresponding to these transitions may also be specified, which correspond to the various control signal derived from the input stream. The ability to custom build the Markov graph allows for control of the element behavior for a wide range of control signals from the input stream.

E. Coupling with Audio Video Signals

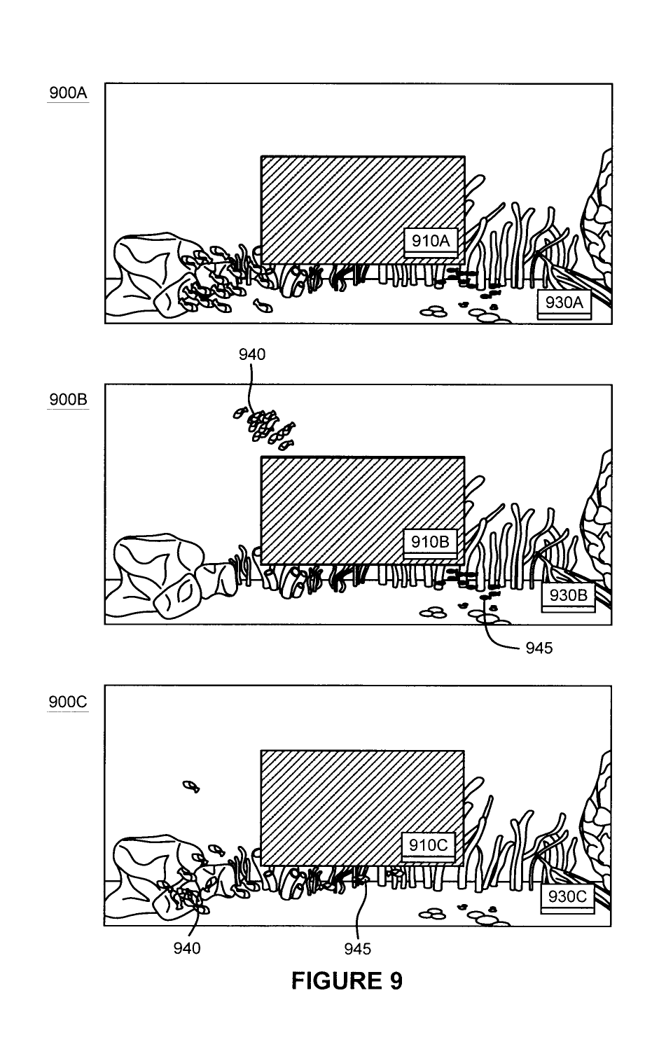

To demonstrate the various features of the animation framework, a fish tank simulation is depicted in FIG. 9. Elements in the fish tank simulation were coupled to audio and video control signals obtained from an input stream 910.

Depicted in FIG. 9 is responsive fish tank surround visual field 930 with two schools of fish 940 and 945 responsive to an input stream 910. A few examples related to coupling the simulation with the input stream are described below.

1. Coupling Light Sources with Video Color:

In an embodiment, the color of the fish tank may be designed to relate with colors of the input video 910. In the depicted embodiment, the fish tank simulation has six point light sources, four at the corners, one behind the tank and one in front of the tank. The colors of the light sources may be obtained by sampling colors from the corresponding video frame. For example, the light source on the top left corner samples its color from the upper left quadrant pixels of the input video stream 91 0. Additionally, the fish tank simulator has a fog source whose density may be coupled to the image colors.

2. Coupling Character Motion with Audio:

In an embodiment, the fish motion (global direction, speed, orientation, etc.) and behavior (swim, scared, etc.) may be controlled by the audio intensity. In the last frame 900C, the fish 940 and 945 are scared by a loud noise in the input video 910C.

In an embodiment, the speed of the fish motion may be coupled with the audio intensity, such that the fish swim faster when there is a lot of audio action in the stream. In order to achieve this, the simulation time step may be varied as follows:

t=t₀×α^{k×vol} (8)

where t₀ is the initial value of the time step; vol is the local control signal representing audio intensity; and α and k are tunable parameters. In the simulation depicted in FIG. 9, α and k were 40 and 3 respectively. Also in the depicted embodiment, the transition from calm to scared behavior for the fish was set if the audio intensity crossed a “scared” threshold, T_{scare}:

$$Behavior = \{ \begin{matrix}Scared , & {exp}^{( - k \times vol )} < {T}_{scared} \\ Calm , & otherwise\end{matrix} \qquad ( 9 )$$

In an embodiment, other methods for coupling the surround visual field with control signal from the input stream may include using motion vectors to affect the object motion. The above examples were provided for purposes of illustration only and shall not be used to narrow the invention. One skilled in the art will recognize other control signals which may be obtained from the input stream and other coupling rules for linking the control signals to the surround visual field.

F. Surround Visual Field Framework with Growth Model

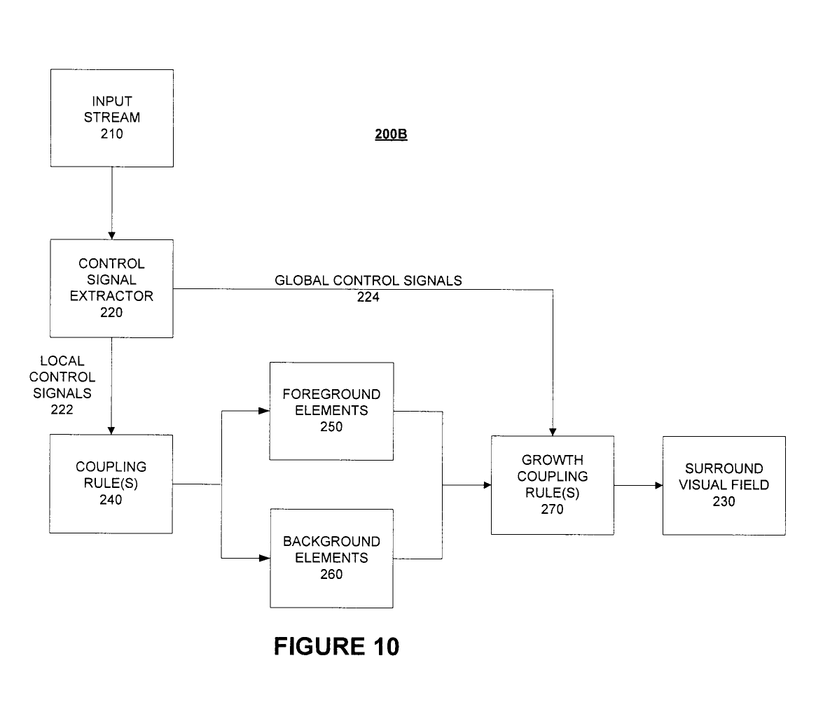

FIG. 10 depicts an alternative embodiment of the surround visual field system or framework 200B, wherein the framework 200 also includes a growth coupling rule or rules. As with the previous embodiment, an input stream 210 is provided to a control signal extractor 220. The control signal extractor 220 may obtain one or more control signals from the input stream. In an embodiment, in addition to local control signals 222, global control signals 224 may also be obtained. Examples of global control signals include, but are not limited to, sampling the signals over time periods. Accordingly, one skilled in the art will recognize that global control signals 224 may be obtained from one or more of the local control signals 222. In an embodiment, the input stream 2 10 may be buffered to allow the system 200B to obtain global control signals 224.

In one embodiment, the global control signals 224 may be provided to one or more growth coupling rules 270, such as a growth model. The growth coupling rules may possess coupling rules for linking foreground 250 and/or background 260 elements in the surround visual field to one or more growth models. In an embodiment, a growth coupling rule may be used to allow the surround visual field to evolve over the course of the presentation.

It should be noted that the addition of one or more growth coupling rules allows for even more robustness and responsiveness of the surround visual field. In addition to instantaneous changes from local control signals and their associated coupling rules, longer term aspects or patterns in the input stream 210 may be introduced into the surround visual field through one or more growth coupling rules.

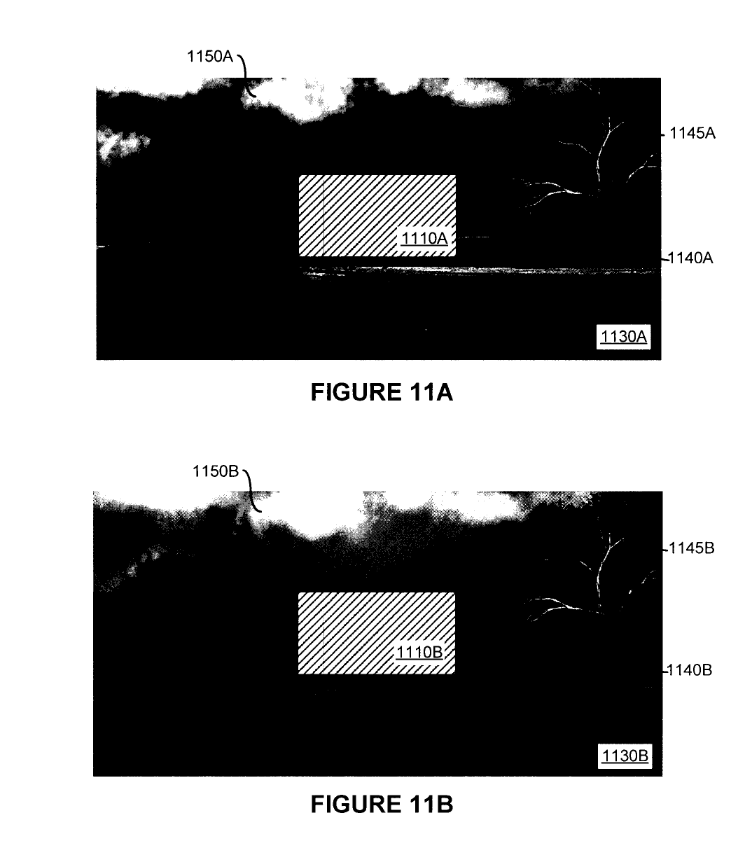

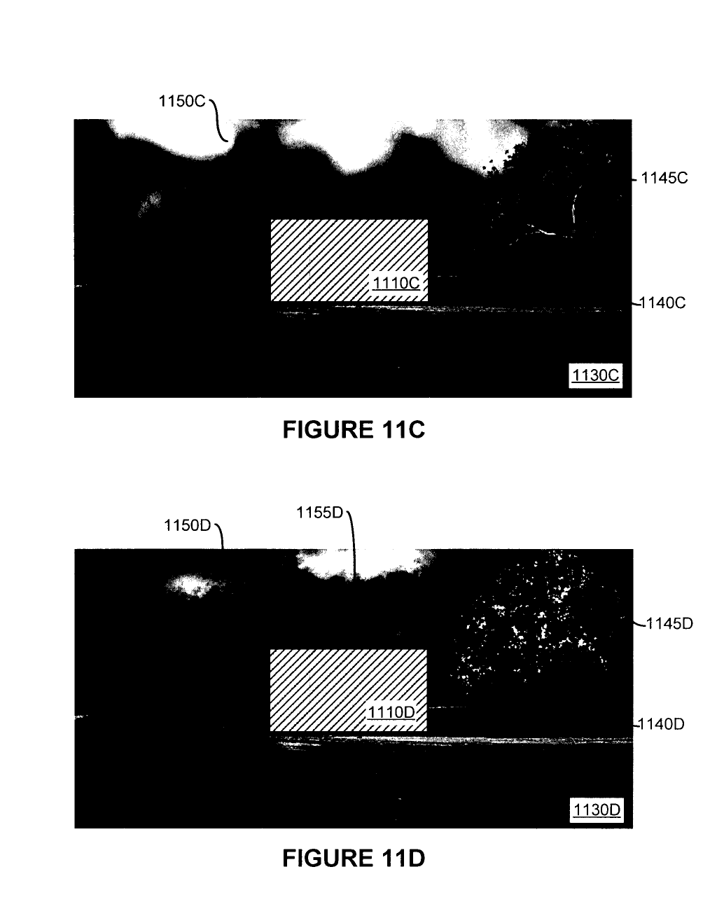

In an embodiment, the growth coupling rule may consider the “age” of an element or elements in the surround visual field. Consider, for example, the surround visual field 1130 presented in FIGS. 11A-D. FIG. 11A depicts an exemplary surround visual field 1130A comprised of a plurality of elements. Included within the surround visual field is a young tree 1140A with a few leaves 1145A. In an embodiment, motion and/or color of the tree 1140A may be affected by local control signals and coupling rules. Similarly, motion and/or color of clouds 1150A in the sky may be affected by local control signals and coupling rules. In addition to the contemporaneous or near contemporaneous changes to elements of the surround visual field 1130 due to local control signals and their associated coupling rules, elements of the surround visual field 1130 may also be affected by global control signals and growth coupling rules. For example, as depicted in FIG. 11B, the tree 1140B is beginning to grow additional leaves 1145B.

In an embodiment, the global control signal and/or growth coupling rules may represent patterns in the input stream. Consider for example the evolving surround visual field depicted in FIG. 11C. Extended periods of somber audio tones or dark colors in the video frame may be used as global control signals are provided to a growth coupling rule to have the surround visual field react. Responsive to such control signals, the depicted embodiment in FIG. 11C has developed more clouds and darker cloud 1150C, and the tree 1140C has continued to grow leaves but is also composed of darker colors that related to input stream. The surround visual field may continue to evolve or grow according to the global control signals and one or more growth coupling rules such that the tree 1140D begins to shed its leaves 1155D. It should be noted one or more characteristics (such as, for example, motion and color) of the leaves 1155D/1145D may be also be affect by local control signals and their coupling rules. Thus, for example, elements within the visual field may grow/evolve in addition to being subjected to local control signal, thereby providing the surround visual field with additional robustness and depth. That is, it shall be noted that an element within the surround visual field may be affected, simultaneously and/or consecutively, by multiple control signals and coupling rules, whether local or global.

It should be noted that no particular implementation of the growth model 270 or the framework 200 is critical to the present invention. One skilled in the art will recognize other implementations and uses the surround visual field framework 200, which are within the scope of the present invention.

G. Exemplary Method for Generating a Surround Visual Field According to an Embodiment

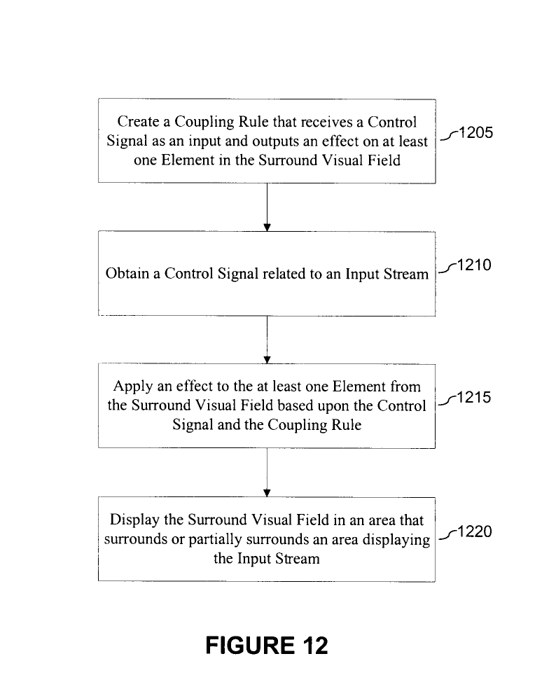

Turning now to FIG. 12, an exemplary method for generating a surround visual field according to an embodiment of the invention is depicted. One skilled in the art will recognize that other methods have been disclosed or may be derived from the descriptions provided above. In an embodiment, a method for generating a surround visual field may comprise the step of creating or defining (1205) a coupling rule that receives a control signal as an input and outputs an effect on at least one element in the surround visual field. The surround visual field typically comprises a plurality of elements, which may include, but is not limited to, images, patterns, colors, shapes, textures, graphics, texts, objects, characters, and the like. An element of the surround visual field may be a foreground element or a background element. An element of a surround visual field may be construed to mean the surround visual field or any portion thereof, including without limitation, a pixel, a collection of pixels, an image, pattern, shape, texture, graphic, text, object, character, and the like, and/or a group of such items. In an embodiment, a user may define or alter the coupling rule.

An input stream may be analyzed to obtain (1210) the control signal that is related to an input stream. As discussed above, the control signal may relate to the input stream by extracting or obtain a characteristic from the input stream, such as, for example, motion, color, audio signal, and/or content. The control signal may then be supplied to the coupling rule to generate an affect that may be applied (1215) to at least one element of the surround visual field. In an embodiment, the effect may be applied to multiple elements in the surround visual field. In one embodiment, an element may have more than one effect applied to it wherein the resulting effect may be the superposition of all the effects applied to the element.

It should also be noted that the effect on elements within the surround visual field, particularly like elements, may be different. Consider, by way of illustration, a school of fish in a surround visual field. A coupling rule may receive audio control signals as an input and output the motion of the fish. Given the same input, the reaction of each element (i.e., each fish in the school of fish) may be different. The reaction may be different due to additional control signal inputs, parameters, probabilities, or the like. The fish may scatter in different direction and create different flocking groups. The flocking behavior may be part of the local coupling rule and/or part of a growth coupling rule.

Finally, the surround visual field may be displayed (1220) in an area that surrounds or partially surrounds an area displaying the input stream, thereby enhancing the viewing experience for a user or users.

In the embodiment depicted in FIG. 12, it should be noted that the control signal and coupling rule may be (1) a local control signal and coupling rule; (2) a global control signal and a growth coupling rule; and (3) both.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application-specific integrated circuits (ASICs), programmable logic devices (PLDs), flash memory devices, and ROM and RAM devices. Examples of computer code include machine code, such as produced by a compiler, and files containing higher level code that are executed by a computer using an interpreter.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

We claim:

1. A method for generating a surround visual field comprising a plurality of elements, the method comprising:
creating a coupling rule that receives a control signal as an input and outputs an effect on at least one element from the plurality of elements of the surround visual field;
obtaining the control signal that is related to an input stream;
applying an effect to the at least one element from the plurality of elements of the surround visual field based upon the control signal and the coupling rule; and
displaying the surround visual field in an area that surrounds or partially surrounds an area displaying the input stream.

2. The method of claim 1 wherein the at least one element is an articulate element.

3. The method of claim 2 wherein the coupling rule comprises a behavior model.

4. The method of claim 3 wherein the behavior model comprises a plurality of motion clips of the at least one element and wherein a transition between two of the plurality of motion clips of the at least one element is related to the control signal.

5. The method of claim 1 wherein the at least one element is a background element or a foreground element.

6. A computer-readable medium carrying one or more sequences of instructions which, when executed by one or more processors, cause the one or more processors to perform at least the steps of claim 1.

7. The method of claim 1 wherein the coupling rule is one selected from the group comprising: a coupling rule associated with a local control signal and a growth coupling rule associated with a global control signal.

8. The method of claim 1 wherein the control signal is a local control signal and the method further comprises the steps of:
creating a growth coupling rule that receives a global control signal as an input and outputs an effect on a second at least one element from the plurality of elements of the surround visual field;
obtaining the global control signal that is related to the input stream; and
applying an effect to the second at least one element from the plurality of elements of the surround visual field based upon the global control signal and the growth model.

9. The method of claim 8 wherein the at least one element and the second at least one element are the same element.

10. The method of claim 8 wherein the global control signal is derived from one or more local control signals.

11. A computer-readable medium carrying one or more sequences of instructions which, when executed by one or more processors, cause the one or more processors to perform at least the steps of claim 1.

12. A surround visual field system for generating a surround visual field comprising a plurality of elements, wherein the surround visual field is displayed in an area surrounding or partially surrounding an input stream, the system comprising:
a control signal extractor that receives the input stream and obtains a control signal that is related to the input stream; and
a coupling rule that receives the control signal as an input and outputs an effect on at least one element from the plurality of elements of the surround visual field.

13. The system of claim 12 wherein the element is an articulated element.

14. The system of claim 13 wherein the coupling rule comprises a behavior model.

15. The system of claim 14 wherein the behavior model comprises a plurality of motion clips of the at least one element and wherein a transition between two of the plurality of motion clips of the at least one element is related to the control signal.

16. The system of claim 12 wherein the control signal extractor that receives the input stream obtains a local control signal that is related to the input stream and a global control signal that is related to the input stream, and wherein the system further comprises a growth coupling rule that receives the global control signal as an input and outputs an effect on a second at least one element from the plurality of elements of the surround visual field.

17. The system of claim 16 wherein the at least one element and the second at least one element are the same element.

18. The system of claim 12 further comprising a display device for displaying the surround visual field in an area that surrounds or partially surrounds an area displaying the input stream.

19. A method for generating a surround visual field that is responsive to an input stream, the method comprising:
obtaining a local control signal that is related to the input stream and a global control signal that is related to the input stream;
affecting a foreground or background element of the surround visual field based upon the local control signal and a coupling rule; and
affecting a foreground or background element of the surround visual field based upon a growth coupling rule and the global control signal.

20. The method of claim 19 further comprising the steps of:
displaying the input stream in a first area; and
displaying the surround visual field in a second area that at least partially surrounds the first area.
